(19) United States
(12) Patent Application Publication
(10) Pub. No.: US 2024/0335046 A1
(43) Pub. Date: Oct. 10, 2024

(54) ADJUSTABLE SEATING AREA FOR PERSON WITH REDUCED MOBILITY

(71) Applicant: Delta Air Lines, Inc., Atlanta, GA (US)

(72) Inventors: Sean Vincent Lopes, Falls Church, VA (US); Mitchell R. Rife, Hampton, GA (US); Rang Saeed, Decatur, GA (US); Myles Duncan Sim, Smyrna, GA (US)

(21) Appl. No.: 18/498,954

(22) Filed: Oct. 31, 2023

Related U.S. Application Data
(60) Provisional application No. 63/494,575, filed on Apr. 6, 2023.

(51) Int. Cl. A47C 13/00; A47C 7/38; A47C 7/54; A47C 7/70; B60N 2/02; B60N 2/24; B60N 2/75; B60N 2/865

(52) U.S. Cl. CPC A47C 13/00; A47C 7/38; A47C 7/541; A47C 7/70; B60N 2/0224; B60N 2/245; B60N 2/77; B60N 2/865; A47C 1/121; B60N 2/242; B63B 29/04; B63B 2029/043; B64D 11/06

(57) ABSTRACT

Adjusting a seat to accommodate a person with reduced mobility (PRM) device. Specifically, a seating apparatus includes a seat having a seatback and a base that is foldable against the seatback to accommodate the PRM device and a console adjacent to the seat. At least a portion of the console is vertically adjustable with respect to the seatback to enable use of the console from the PRM device when the PRM device is positioned proximate to the seatback.

### CROSS-REFERENCE TO RELATED APPLICATION

This application claims the benefit of priority under 35 U.S.C. § 119 (e) to U.S. Provisional Patent Application No. 63/494,575, entitled “ADJUSTABLE SEATING AREA FOR PERSON WITH REDUCED MOBILITY,” filed on Apr. 6, 2023, which is hereby incorporated by reference in its entirety.

### BACKGROUND

A person with reduced mobility (PRM) who uses a wheelchair may sometimes need seating accommodations, such as in public transportation vehicles (trains, airplanes, buses, etc.). Most airplanes do not have the needed accommodations for a wheelchair, scooter, stroller, etc. As a result, these items or devices are stored in separate baggage areas and may become lost or damaged. There is an associated financial loss to the carrier to replace or repair damaged wheelchairs. In addition, the PRM may not be able to function without their wheelchair. Further, it is inconvenient and sometimes nearly impossible or very difficult for the PRM to transfer into a seat such as an airplane seat.

### BRIEF DESCRIPTION OF THE DRAWINGS

FIG. 1 is a diagram illustrating a seating apparatus that accommodates a PRM device, according to an example embodiment.

FIG. 2 is a diagram illustrating a seating apparatus having an adjustable console to accommodate a user in a PRM device, according to an example embodiment.

FIGS. 3A and 3B are views, from various perspectives, illustrating the adjustable console of FIG. 2 in a standard position with one or more console-based features stowed therein, according to an example embodiment.

FIGS. 4A and 4B are views, from various perspectives, illustrating the adjustable console of FIG. 2 in a standard position in which one or more console-based features are deployed, according to an example embodiment.

FIGS. 5A and 5B are views, from various perspectives, illustrating the adjustable console of FIG. 2 in a PRM position in which one or more console-based features are stowed therein, according to an example embodiment.

FIGS. 6A and 6B are views, from various perspectives, illustrating the adjustable console of FIG. 2 in the PRM position in which one or more console-based features are deployed, according to an example embodiment.

FIGS. 7A-7C are views, from various perspectives, illustrating components of a console adjustment mechanism of FIGS. 3A-6B, according to an example embodiment.

FIG. 8 is a flow diagram illustrating a method of adjusting an inboard half of the adjustable console of FIG. 2, according to an example embodiment.

FIG. 9 is a diagram illustrating a seating apparatus in which a headrest is adjustable between a standard position and a PRM position, according to an example embodiment.

FIGS. 10A and 10B are side views illustrating the headrest of FIG. 8 being adjusted between the standard position and the PRM position, according to an example embodiment.

FIG. 11 is a flowchart illustrating a method of adjusting a vertical position of a console, according to an example embodiment.

### DESCRIPTION OF EXAMPLE EMBODIMENTS

### Overview

Briefly, an adjustable console and/or an adjustable headrest for a seat is provided to accommodate a person with reduced mobility (PRM) device.

More specifically, in one form, a seating apparatus is provided. The seating apparatus includes a seat having a seatback and a base that is foldable against the seatback to accommodate a person with reduced mobility (PRM) device. The seating apparatus further includes a console adjacent to the seat. At least a portion of the console is vertically adjustable with respect to the seatback to enable use of the console from the PRM device when the PRM device is positioned proximate to the seatback.

In another form, a seating apparatus is provided. The seating apparatus includes a seat having a seatback and a base that is foldable against the seatback to accommodate a person with reduced mobility (PRM) device and a console adjacent to the seat. The console includes an outboard half configured to be fixed in place and an inboard half configured to be vertically adjustable to be accessible from the PRM device when the PRM device is positioned proximate to the seatback.

In yet another form, a method is provided. A method includes releasing a lock to fold a seatback of a seat against a base of the seat. The seatback is adjustable between a first position configured to accommodate seating of a user and a second position in which the base is stowed against the seatback to accommodate a person with reduced mobility (PRM) device. The method further includes adjusting a vertical position of a console that is adjacent to the seat to enable use of the console from the PRM device when the seat is in the second position and the PRM device is positioned proximate to the seatback.

In yet another form, a seat console apparatus is provided. The seat console apparatus includes a frame that is configured to be positioned between a first seat and a second seat. The second seat is convertible between a first position to accommodate seating of a user and a second position to accommodate a person with reduced mobility (PRM) device. The seat console apparatus further includes a console adjustment mechanism configured to move at least a portion of the frame between the first position and the second position.

### EXAMPLE EMBODIMENTS

It is not unusual for a person with reduced mobility (PRM) to avoid public or private spaces that lack special accommodations for their PRM devices. PRM devices aid transport or movement of a person. The PRM devices come in a variety of sizes and formats to meet specific needs of their users. For example, the PRM devices include but are not limited to wheelchairs, strollers, scooters, etc.

While some seating areas have a space for the PRM device, and even include securing mechanisms to secure the PRM device therein, more is needed. Typically, other aspects of the seating area remain neglected. Other aspects of the seating area may include but are not limited to console-based features such as armrests or tray tables, headrests, center consoles, side tables, footrests, etc.

For example, a common design for accommodating a wheelchair in various settings such as a vehicle, a movie theater, etc. involves removing or lifting the seat cushion to an upright position and placing the PRM device in the seating area without addressing any other aspects of the seating area.

While example embodiments described below relate to an aircraft seating area i.e., aircraft seats or seating aisles, the disclosure is not limited thereto and is applicable to other vehicles (e.g., cars) and/or places (e.g., theaters, auditoriums, stadiums, etc.) in which the seating area needs to be adjusted to accommodate a PRM device. For example, the seating apparatus may be in a vehicle such as a public transportation vehicle (bus, minivan, etc.) or a boat, cruise ship, motorboat, etc. As another example, the seating apparatus may be in an airplane, helicopter, etc. The placement of a seating apparatus or a method thereof described below may depend on a particular use case scenario.

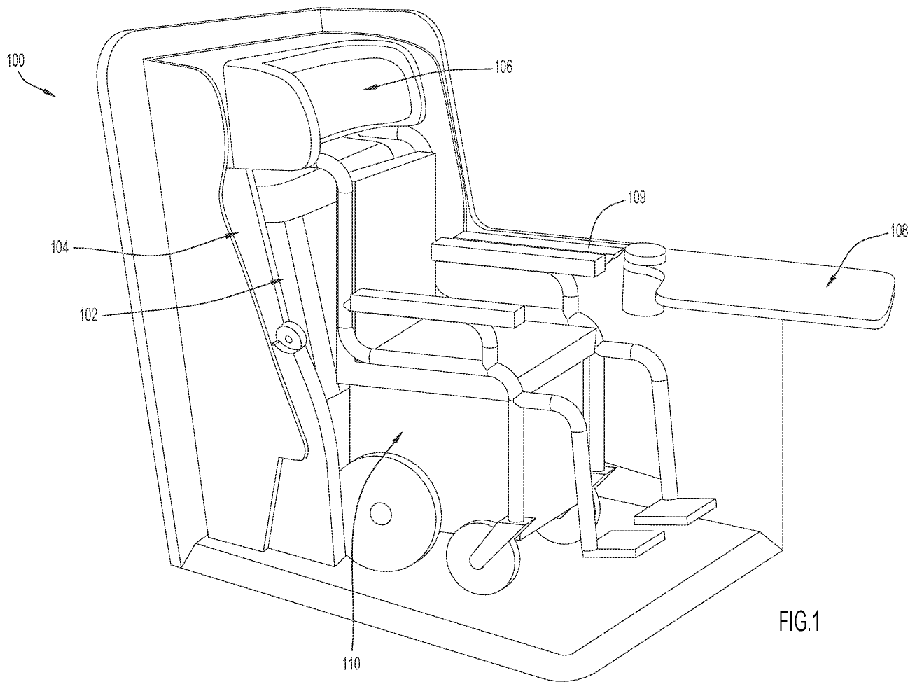

FIG. 1 is a diagram illustrating a seating apparatus 100 that accommodates a PRM device 110, according to an example embodiment. The seating apparatus 100 has a base 102, a seatback 104, a headrest 106, and a tray table 108 attached to a console 109.

The tray table 108 is a non-limiting example of a console-based feature. Other console-based features may include a cup holder, a magazine holder, a book holder, media controls. In one example embodiment, the console 109 may be without any console-based features e.g., an armrest or a divider.

The base 102 is foldable against the seatback 104 but the disclosure is not limited thereto. For example, the base 102 may include a frame and a removable cushion (not shown). To accommodate the PRM device 110, the cushion is removed and the frame of the base 102 is stowed against the seatback 104. In FIG. 1, the base 102 is folded and stowed against the seatback 104 to accommodate the PRM device 110.

In one example embodiment, the seatback 104 may have a removable cushion (not shown). When the cushion is removed, it creates a space for stowing away the base 102 when the base 102 is folded and pressed against the seatback 104. In yet another example embodiment, the seatback 104 may have an integrally formed cushion such that when the base 102 is folded against the seatback 104 (i.e., stowed), the base 102 protrudes with respect to the seatback 104.

The headrest 106 and the tray table 108 are examples of aspects in a seating area that are typically neglected and not adjusted to accommodate the PRM device 110. In one or more example embodiments, however, these aspects of the seating area are configured to be adjusted to accommodate the PRM device 110 i.e., for use by a user in the PRM device 110 when the PRM device 110 is positioned proximate to the seatback 104. In one or more example embodiments, the headrest 106 and the tray table 108 along with the console 109 are adjustable to various positions to accommodate a user in the PRM device 110.

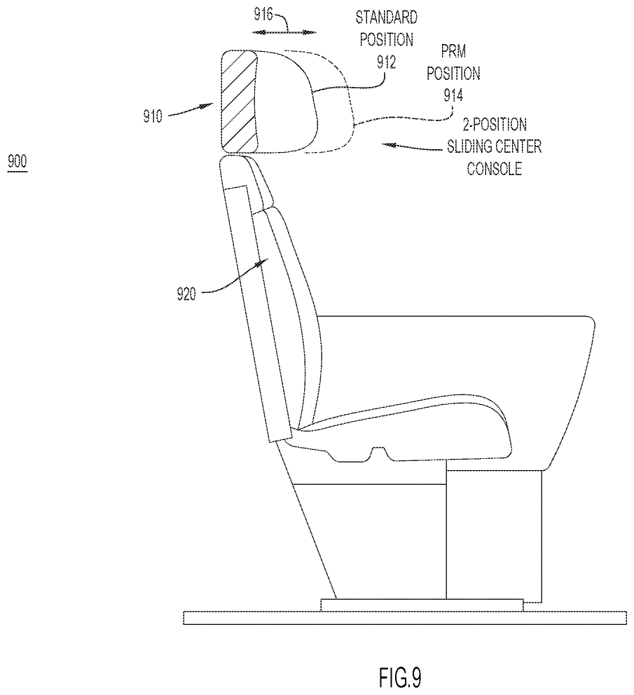

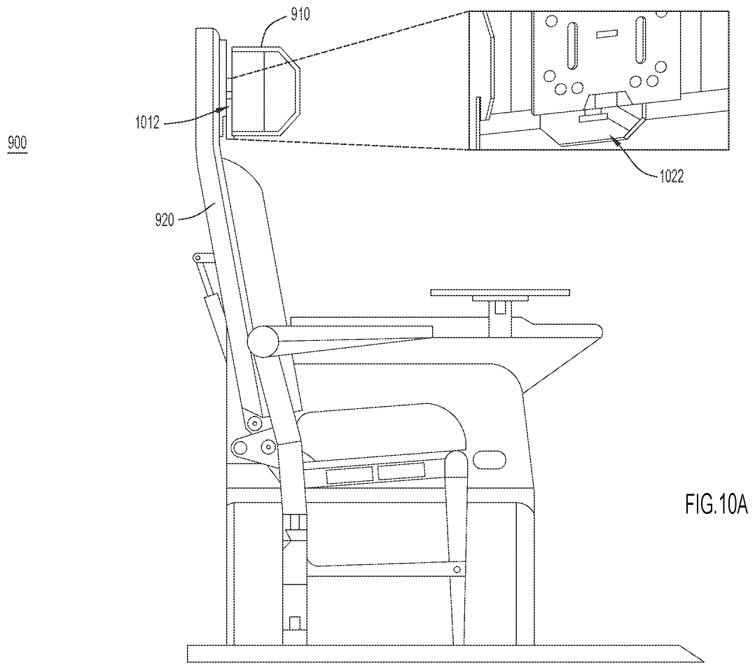

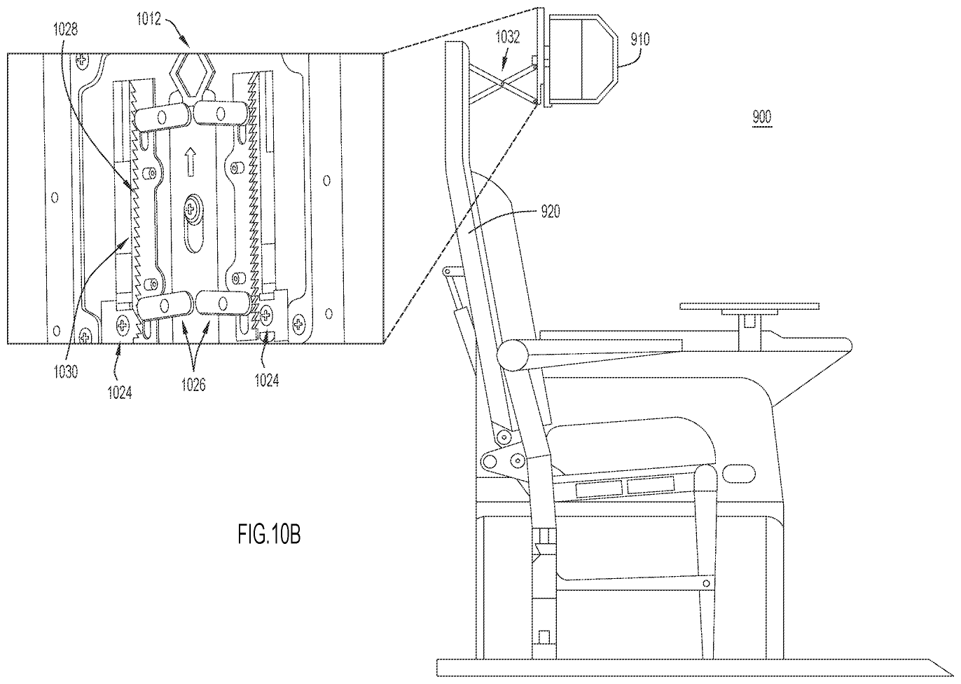

The headrest 106 may be adjustable not just in a vertical direction i.e., up and down parallel to the seatback 104 but also in a horizontal direction i.e., forward (away from the seatback 104) and aft (toward the seatback 104). One or more example embodiments of the headrest 106 are provided below with reference to FIGS. 9, 10A and 10B.

The tray table 108 is an example of a console-based feature. The tray table 108 may be integrally formed with the console 109 and/or stowed within the console 109, as discussed in detail below. The tray table 108 may be attached to the console 109 to be adjustable with the console 109. As noted above, the tray table 108 is just one example of a console-based feature. A console-based feature may be a video monitor, an armrest, a cup holder, a magazine holder, a book holder, and/or media controls.

The seating apparatus 100 is configured to adjust the console 109 such that the console-based feature e.g., the tray table 108 is accessible to a user in the PRM device 110. For example, the console 109 is vertically adjustable with respect to seatback 104 to enable use of the console 109 and/or access to the console-based feature(s) from the PRM device 110 when the PRM device 110 is positioned proximate to the seatback 104. These are just some non-limiting examples of adjusting the seating apparatus 100 to accommodate the PRM device 110.

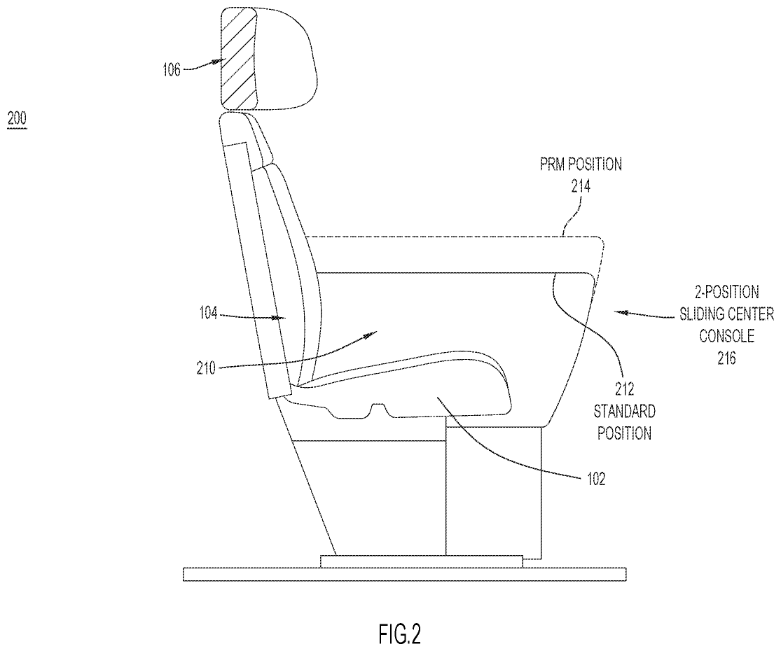

With continued reference to FIG. 1, FIG. 2 is a diagram illustrating a seating apparatus 200 having an adjustable console 210 to accommodate a user in a PRM device (not shown), according to an example embodiment. The seating apparatus 200 includes the base 102, the seatback 104, and the headrest 106 of FIG. 1, and the adjustable console 210.

In one example embodiment, the adjustable console 210 is a center console. A center console is positioned between the seating apparatus 200 and an adjacent seat that has another seatback and another base. For example, the adjustable console 210 maybe an armrest shared between two adjacent seats. As another example, the adjustable console 210 may include a first feature for the seating apparatus 200 e.g., a first tray table and a second feature for the adjacent seat e.g., a second tray table.

Existing center console designs (such as the ones in an aircraft) are typically rigid and do not allow for vertical adjustments to accommodate the user. Passengers and/or flight attendants cannot adjust the height of an existing center console to better suit their convenience. The adjustable console 210, on the other hand, includes a console adjustment mechanism for a position-adaptable design such that passengers seated in their own wheelchairs can position the adjustable console 210 for their use. Specifically, the adjustable console 210 may be lowered or raised to enable the PRM user easy access to one or more console-based features of the adjustable console 210. As noted above, some examples of the console-based features may include but are not limited to the tray table 108 of FIG. 1, a video monitor, an armrest, a cup holder, a magazine holder, a book holder, and/or media controls.

In one example embodiment, the adjustable console 210 is a center console that is configured to be used by the seating apparatus 200 and an adjacent seat. As such, the adjustable console 210 may be split into two halves (i.e., split down approximately the centerline): an inboard half and an outboard half. The inboard half is for use by a user in the seating apparatus 200 and configured to be adjusted (raised and lowered) to accommodate the user in a PRM device. The inboard half is adjustable between a standard position 212 and a PRM accessible position (a PRM position 214). The PRM position 214 is ergonomically well suited for the PRM e.g., a wheelchair passenger. On the other hand, the outboard half (not shown) may be fixed in place (i.e., the adjacent seat is not configured to accommodate the PRM).

In one example embodiment, the adjustable console 210 slides up from the standard position 212 to the PRM position 214, as shown at 216. For example, the adjustable console 210 may be raised by approximately 3-5 inches for use by a user in the PRM device e.g., a wheelchair. This, however, is just one example. In another example embodiment, the adjustable console 210 may slide down (be lowered) from the standard position 212 to another PRM position (not shown) to accommodate the user in the PRM device e.g., a mobility scooter. This disclosure is not limited thereto. Adjustments (e.g., vertical) of the adjustable console 210 may vary depending on a particular use case scenario. Moreover, while one or more example embodiments describe vertical adjustments of the adjustable console 210, the adjustments are not limited thereto. The adjustments may include horizontal adjustments (e.g., as described with respect to the headrest in FIGS. 9-10B) or a combination of vertical and horizontal adjustments e.g., the adjustable console 210 is adjusted forward and up at a predetermined angle.

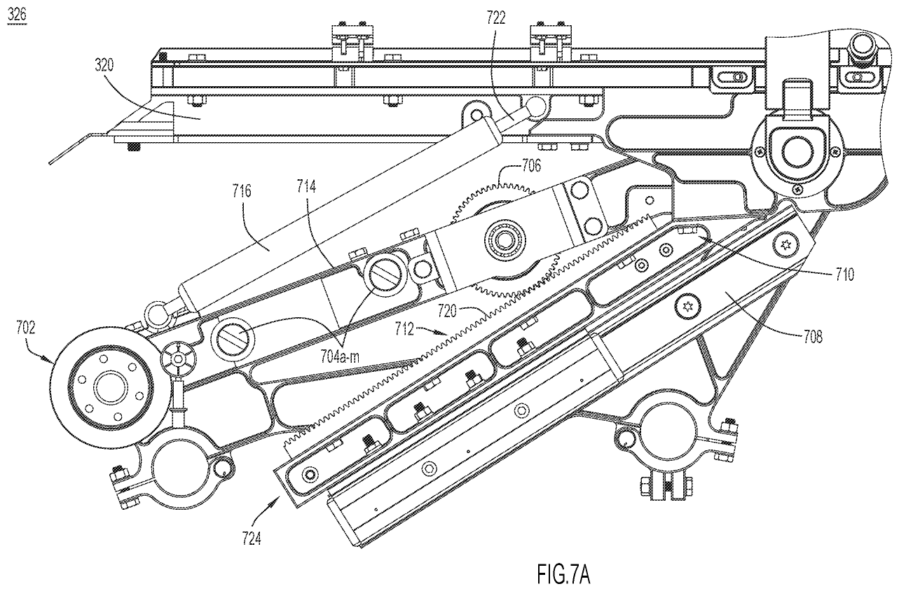

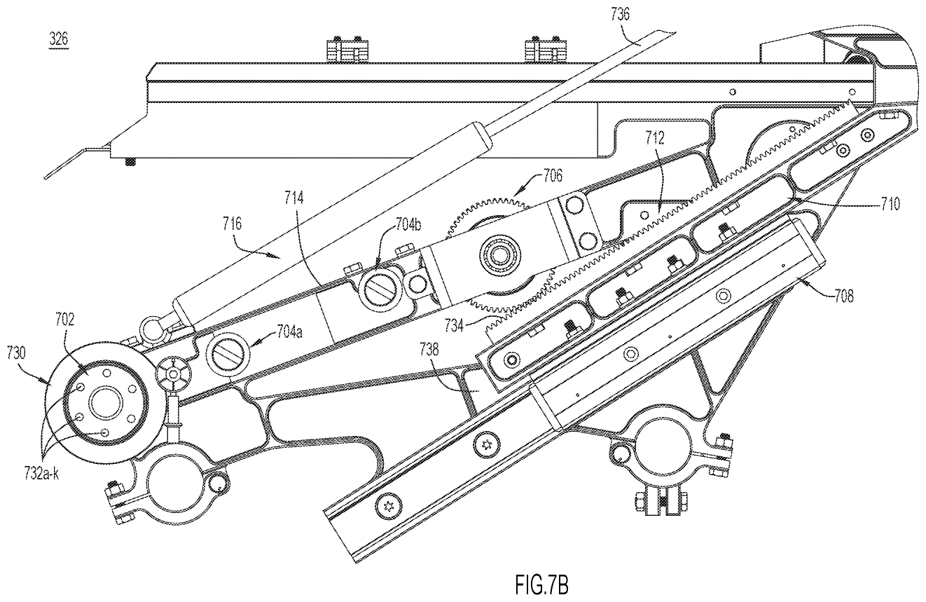

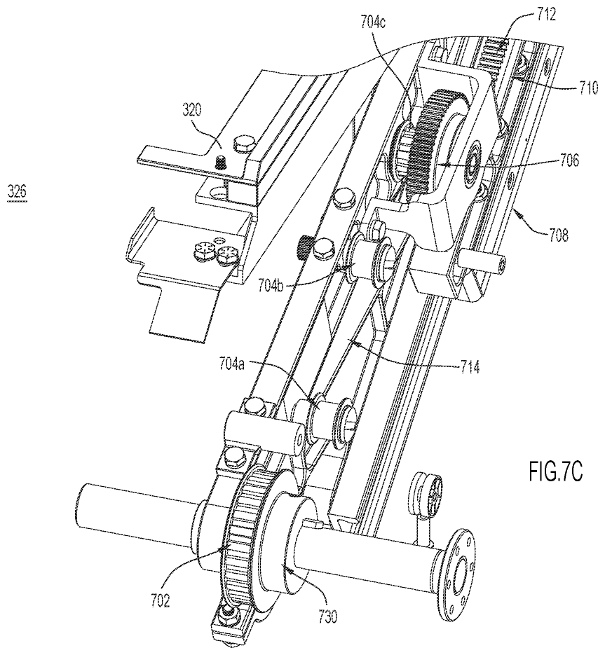

In one example embodiment, a console adjustment mechanism is configured to adjust the adjustable console 210 (e.g., the inboard half) for accessing a console-based feature from the PRM device. One or more example embodiments of the console adjustment mechanism are described with reference to FIGS. 7A-7C.

The console adjustment mechanism may be linked to or connected with a seat or a seat frame that is configured to convert between the standard position 212 and the PRM position 214 for use by a PRM user e.g., a PRM passenger in an aircraft. The adjustable console 210 is configured to be adjusted based on the base 102 being folded against the seatback 104. For example, when an activation of a button is detected, the seating apparatus 200 is converted from the standard position 212 to the PRM position 214. This is just one non-limiting example.

In yet another example embodiment, the adjustable console 210 may operate independently of the seat being adjusted for the PRM device. For example, the base 102 is folded against the seatback 104 and the PRM device is secured in the seating apparatus 200. Then, the PRM user activates the console adjustment mechanism to lower or raise the adjustable console 210 such that it and its console-based features are accessible to the PRM user in the PRM device. In yet another example embodiment, the adjustable console 210 is adjusted to the PRM position 214 together with the base 102 being folded against the seatback 104 (co-dependently, synchronously) but then the PRM user may further adjust the adjustable console 210 specific to their PRM device and their individual convenience.

In one or more example embodiments, when the adjustable console 210 is configured to accommodate a first user in the seating apparatus 200 and a second user in an adjacent seat, the adjustable console 210 may be split into two halves i.e., one for the seating apparatus 200 and another for the adjacent seat. These two halves may be configured to be independently adjustable and may be substantially of equal size. Two independent mechanisms may be included within the body of the adjustable console 210 to independently adjust the respective side of the adjustable console 210 i.e., to raise or lower the respective side between the standard position 212 and the PRM position 214.

Further, while two positions (the standard position 212 and the PRM position 214) are described in detail, this is just an example. The adjustable console 210 may be adjusted to a plurality of positions for various types and sizes of users that are using different PRM devices. For example, a fixing or locking mechanism may be provided to lock the respective side of the adjustable console 210 to a custom position specific to the passenger's dimensions (size, height, and PRM device type). In one example embodiment, one or more sensors may be included that are configured to detect the PRM device type (e.g., the height and/or other dimensions) and adjust the position of the adjustable console 210 based on the detected characteristics and/or the PRM device type using an actuator and a controller. The position of the adjustable console 210 may be adjusted vertically and/or horizontally e.g., at an angle.

While one or more example embodiments describe the adjustable console 210 as including a console-based feature, this is just an example. The adjustable console 210 may include a variety of console-based features such as a cup holder, a video monitor, a personal device holder, a magazine holder, a book holder, etc. The adjustable console 210 may include a cavity shaped to hold various items. As another example, the console-based features may be an armrest with media controls. As yet another example, the adjustable console 210 may not include any features and simply serve as an armrest or a divider between two adjacent seats.

With continued reference to FIGS. 1 and 2, FIGS. 3A and 3B are views, from various perspectives, illustrating the adjustable console 210 of FIG. 2 in the standard position 212 in which one or more console features are stowed therein, according to an example embodiment.

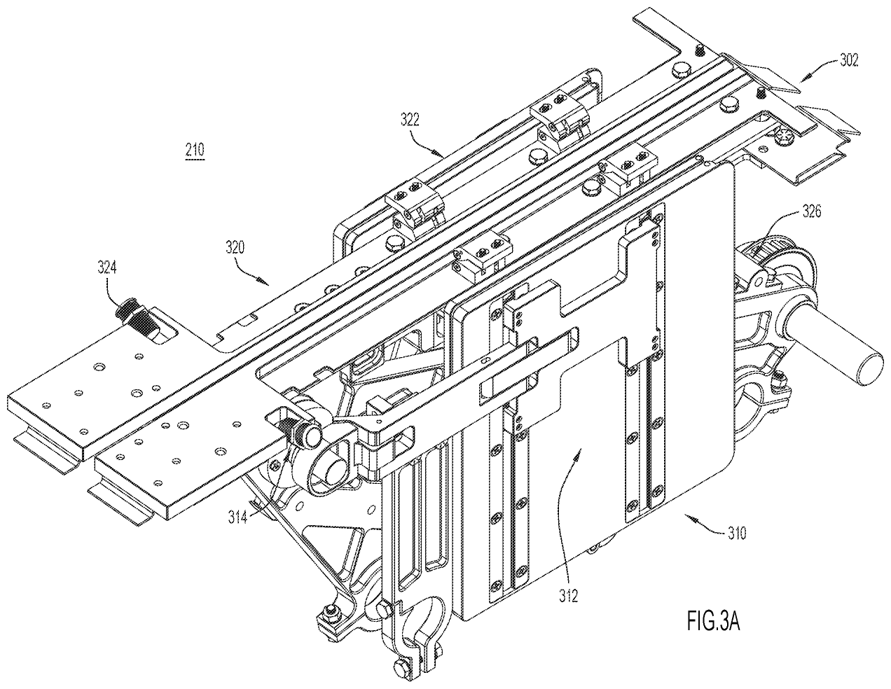

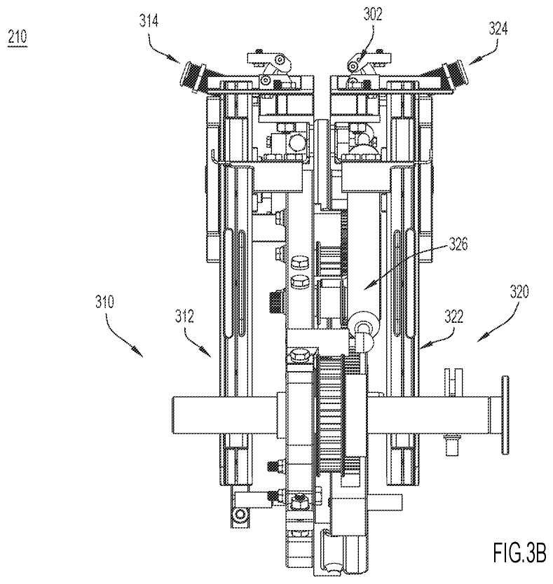

In FIGS. 3A and 3B, the adjustable console 210 is a center console that is positioned between a first seat configured to accommodate a PRM device and an adjacent seat that does not accommodate a PRM device. The adjustable console 210 includes a frame 302 that is split into two halves: an outboard half 310 and an inboard half 320. Unlike a typical console that has a single body and is fixed in place, the adjustable console 210 is split into these two halves and vertical adjustments are enabled at least with respect to one half (e.g., the inboard half 320) using a console adjustment mechanism 326.

The adjustable console 210 includes one or more console-based features. For example, the outboard half 310 includes a first table 312 and a first recline button 314 and the inboard half 320 includes a second table 322 and a second recline button 324. The first table 312 and the second table 322 are connected to or integrally formed with the frame 302. The first recline button 314 and the second recline button 324 are configured to recline the seatback 104 of the seat when the seat is in the standard position 212 and/or in the PRM position 214. In one example embodiment, the seatback 104 may be reclined using the second recline button 324 in the PRM position 214 to provide extra room for the base 102 being folded against the seatback 104.

FIG. 3B is a perspective forward view in which the first table 312 is stowed within the outboard half 310 and the second table 322 is stowed within the inboard half 320, i.e., the console-based features are in a stowed position. The first table 312 and the second table 322 are parallel to each other in the stowed position and align with and/or parallel to the frame 302. In one example embodiment, the first table 312 is configured to connect to the frame 302 at the outboard half 310 and the second table 322 is configured to connect to the frame 302 at the inboard half 320.

The outboard half 310 is fixed in place. The outboard half 310 is stationary and cannot be adjusted to the PRM position 214 of FIG. 2. The outboard half 310 provides access to the first table 312 but only in the standard position 212 of FIG. 2. While the first table 312 may be extended for use by the user, the first table 312 cannot be adjusted vertically i.e., the outboard half 310 does not move.

Unlike the outboard half 310, the inboard half 320 is adjustable from the standard position 212 to the PRM position 214 of FIG. 2 to accommodate a PRM user in a PRM device when the PRM device is positioned proximate to the seatback 104. The inboard half 320 includes a console adjustment mechanism 326 that adjust the inboard half 320 between the standard position 212 and the PRM position 214 (e.g., vertical adjustments).

In one example embodiment, the console adjustment mechanism 326 is a self-contained mechanism that vertically moves the inboard half 320 up and down along the frame 302 (with respect to the seatback 104 of FIG. 1) such that the second table 322 is accessible by a user in the PRM device when the PRM device is positioned proximate to the seatback 104 i.e., secured against the seatback 104.

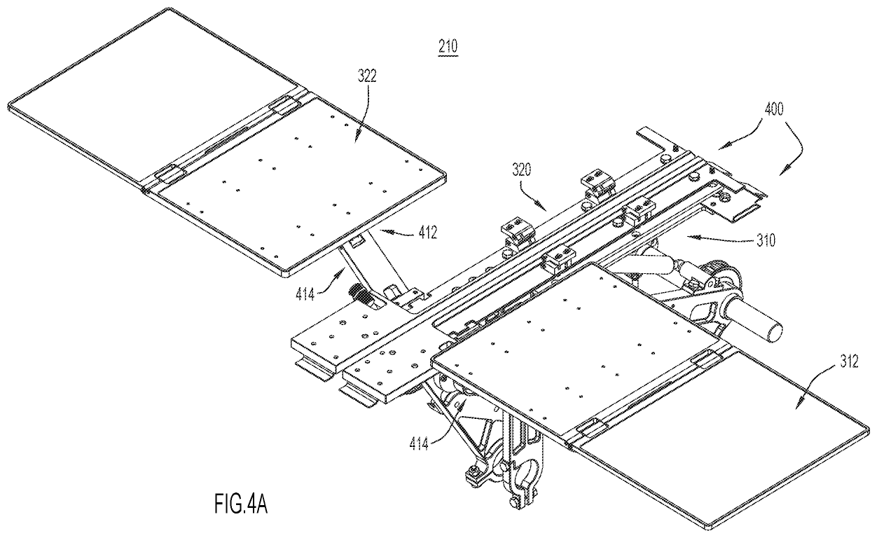

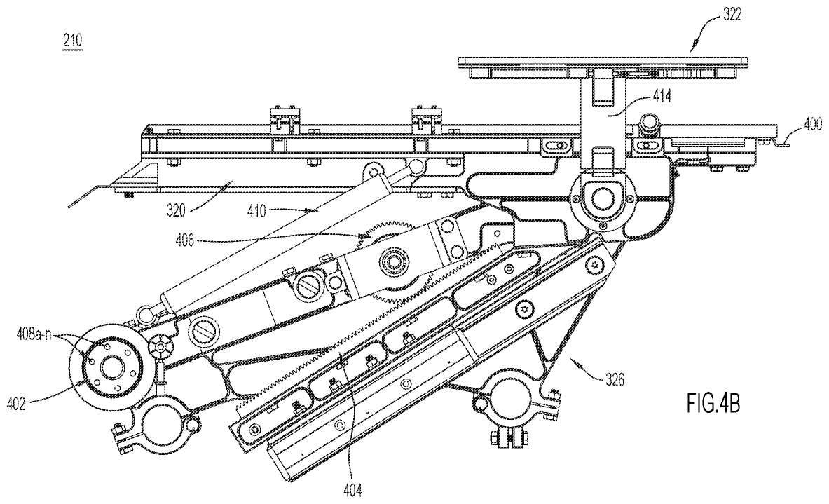

With continued reference to FIGS. 1, 2, 3A and 3B, FIGS. 4A and 4B are views, from various perspectives, illustrating the adjustable console 210 of FIG. 2 in the standard position 212 in which one or more console-based features are deployed, according to an example embodiment. In FIGS. 4A and 4B, the console-based features are deployed for use by users in adjacent seats while the adjustable console 210 is in the standard position 212 i.e., not adjusted to accommodate a PRM device. For example, an armrest or a console is down while the tables are deployed.

In FIG. 4A, the adjustable console 210 includes a base frame 400 (such as the frame 302 of FIGS. 3A and 3B) having the outboard half 310 with the first table 312 and the inboard half 320 with the second table 322. The first table 312 and the second table 322 are configured to extend from a respective half and pivot for use by users such as passengers in an aircraft. Each table may have a pivot 412 mounted directly to a solid flange 414. The solid flange 414 may extend downward and attach to a plurality of tubes (not shown) on the base frame 400.

The first table 312 and the second table 322 are examples of console-based features. For example, the first table 312 and the second table 322 may be food tray tables that are configured to extend against the seats for use by users in their respective seats. The food tray tables may be in a different position and/or orientation i.e., extend in a different direction for use by respective users. As another example, the adjustable console 210 may include a cavity for other console-based features such as a video monitor, a bottle holder, magazine holder, a book holder, etc. instead of or in addition to the food tray tables. In yet another example, the adjustable console 210 may be without any console-based features (none included) e.g., it may serve as armrests for the adjacent seats and/or an armrest for a single seat.

In FIGS. 4A and 4B, the first table 312 and the second table 322 are deployed while the adjustable console 210 is in the standard position 212. The first table 312 cannot move to the PRM position 214 of FIG. 2 i.e., the outboard half 310 of the adjustable console 210 is fixed i.e., cannot be vertically adjusted. Unlike the outboard half 310, the inboard half 320 is adjustable between the standard position 212 and the PRM position 214 using the console adjustment mechanism 326.

Specifically, in FIG. 4B, the adjustable console 210 is shown from a perspective side view in the standard position 212 while the tables are deployed i.e., looking into the inboard half 320. In the perspective side view of FIG. 4B, the second table 322 is shown along with the console adjustment mechanism 326 that adjusts the inboard half 320. Since the inboard half 320 is maintained in the standard position 212, the second table 322 is on the same level as the first table 312 of the outboard half 310.

In FIG. 4B, components of the console adjustment mechanism 326 include a base rim 402, a rack 404, and a pinion 406, according to one example embodiment. In another example embodiment, instead of the base rim 402, a flange on a drive shaft may be used. The base rim 402 has holes 408a-n that rotate when the adjustable console 210 is being vertically adjusted between the standard position 212 and the PRM position 214. This in turn moves or pulls the rack 404 upwards via the pinion 406. A spring 410 is configured to provide lift assist for vertically raising the inboard half 320. The console adjustment mechanism 326 is described in further detail with reference to FIGS. 7A-7C.

The notations 1, 2, 3, . . . n; a, b, c . . . n; “a-n”, “a-d”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

With continued reference to FIGS. 1, 2, 3A, 4B, 4A and 4B, FIGS. 5A and 5B are views, from various perspectives, illustrating the adjustable console 210 of FIG. 2 in the PRM position 214 in which console-based features are stowed therein, according to an example embodiment.

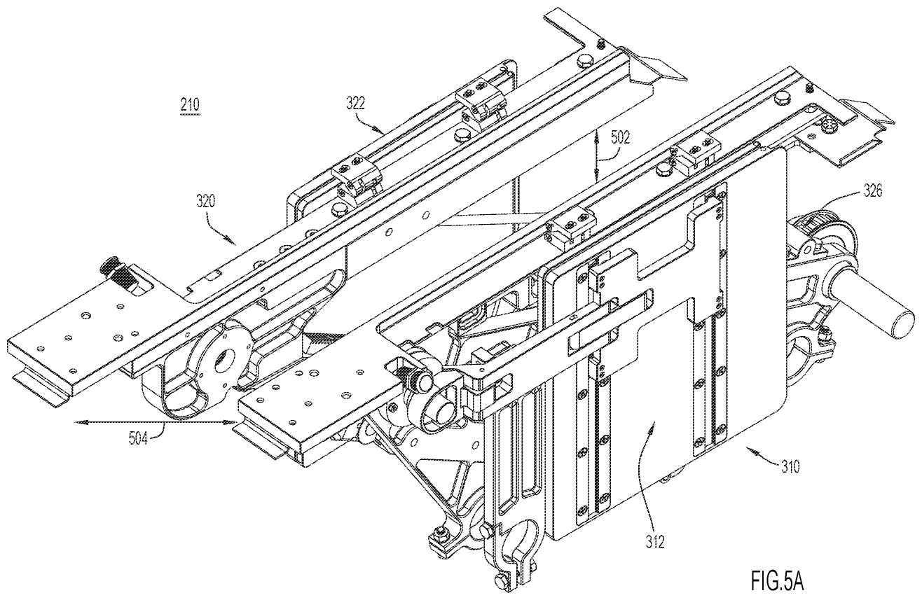

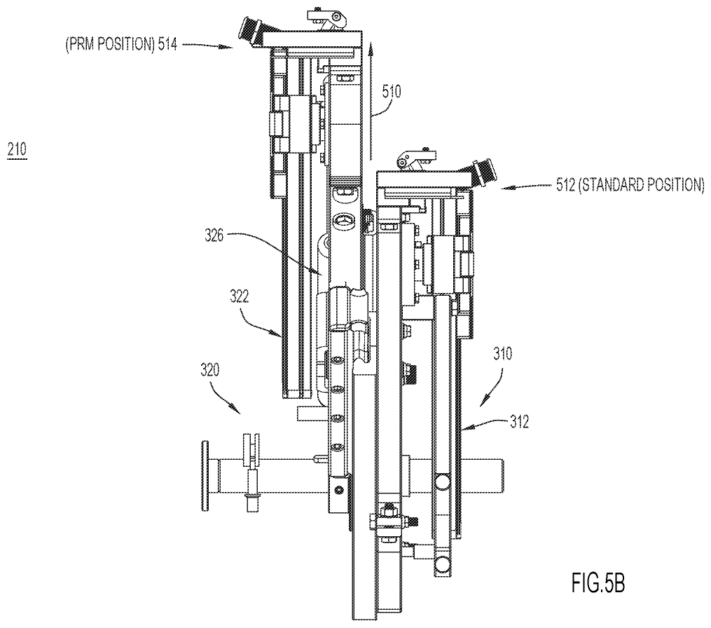

The adjustable console 210 includes the outboard half 310 and the inboard half 320 that is vertically adjustable using the console adjustment mechanism 326. In FIGS. 5A and 5B, the first table 312 and the second table 322 (examples of the console-based features) are stowed within the respective halves and are not yet deployed for use by users in the adjacent seats.

The first table 312 and the second table 322 may be stored within the outboard half 310 and the inboard half 320, respectively, and hidden from the outside. That is, the outboard half 310 and the inboard half 320 may form a housing for these console-based features. In another example embodiment, the console-based features may be attached to the frame of the outboard half 310 and the inboard half 320, respectively, and align with this frame while still being visible from the outside.

In one example embodiment, depending on a PRM device type, the console-based features cannot be deployed until the adjustable console 210 is adjusted to accommodate the PRM device. For example, the PRM device positioned proximate to the seatback may prevent deployment of the second table 322. As such, the inboard half 320 is configured to be adjusted for the second table 322 to be deployed i.e., adjusted to the PRM position 214 of FIG. 2.

In one example embodiment, the PRM position 214 involves raising the inboard half 320 higher than the outboard half 310, shown at 502, by approximately 3-7 inches (along y-axis) to accommodate a user in the PRM device. Specifically, when the base is folded against the seatback and the PRM device is positioned proximate to the seatback, the inboard half 320 is raised and the second table 322 becomes accessible to a user in the PRM device (e.g., wheelchair). Since the inboard half 320 is vertically adjusted, the PRM device secured in the seating area no longer blocks the deployment of the second table 322.

In one example embodiment, the inboard half 320 may further be adjusted horizontally such that a gap 504 may be formed between the outboard half 310 and the inboard half 320. The gap 504 may be approximately 3-7 inches. Since different PRM devices have different dimensions (height and width), the inboard half 320 may be additionally adjusted in a horizontal direction. For example, the inboard half 320 may further slide horizontally away from the outboard half 310 forming the gap 504. As another example, the inboard half 320 may further extend forward in a horizontal direction (away from the seatback) e.g., when the PRM device is a scooter and protrudes forward more than a wheelchair.

FIG. 5B is a perspective aft view in which the inboard half 320 is vertically adjusted with respect to the outboard half 310, shown at 510. The inboard half 320, while only vertically adjusted, is aligned with the outboard half 310. The inboard half 320 abuts against or slides against the outboard half 310 i.e., to be raised or lowered vertically, with respect to the outboard half 310. The outboard half 310 does not move and remains fixed in the standard position 212 of FIG. 2, shown at 512. On the other hand, the inboard half 320 is vertically adjusted to the PRM position 214 of FIG. 2, shown at 514.

With continued reference to FIGS. 1, 2, 3A, 3B, 4A, 4B, 5A and 5B, FIGS. 6A and 6B are views, from various perspectives, illustrating the adjustable console 210 of FIG. 2 in the PRM position 214 in which one or more console-based features are deployed, according to an example embodiment.

The adjustable console 210 includes a frame base 600 that has the outboard half 310 and the inboard half 320. The outboard half 310 is fixed and stationary and the inboard half 320 is adjustable to accommodate a user in a PRM device when the PRM device is positioned proximate to the seat i.e., secured in a seating area.

The console-based features are the first table 312 and the second table 322. The first table 312 and the second table 322 are foldable food tray tables that are deployed for use by users in the adjacent seats. This is just an example. Different console-based features may be provided in the outboard half 310 and the inboard half 320 depending on a particular use case scenario. For example, the outboard half 310 may include the first table 312, whereas the inboard half 320 may include one or more cavities such as a cup holder and a magazine holder instead of the second table 322.

The first table 312 and the second table 322 are deployed for use at different locations with respect to one another. The first table 312 is deployed in the standard position 212 with the outboard half 310 being fixed and immobile, shown at 602. The second table 322 is deployed in the PRM position 214 with the inboard half 320 being raised, shown at 604. Based on an adjustment 606 of the inboard half 320 with respect to outboard half 310, the second table 322 is deployed substantially higher than the deployment position of the first table 312. The adjustment 606 may include vertical and/or horizontal adjustments including along the x-axis, y-axis, and z-axis depending on a particular deployment and use case scenario. Based on the adjustment 606. the second table 322 is easily accessible by a PRM in a wheelchair, for example.

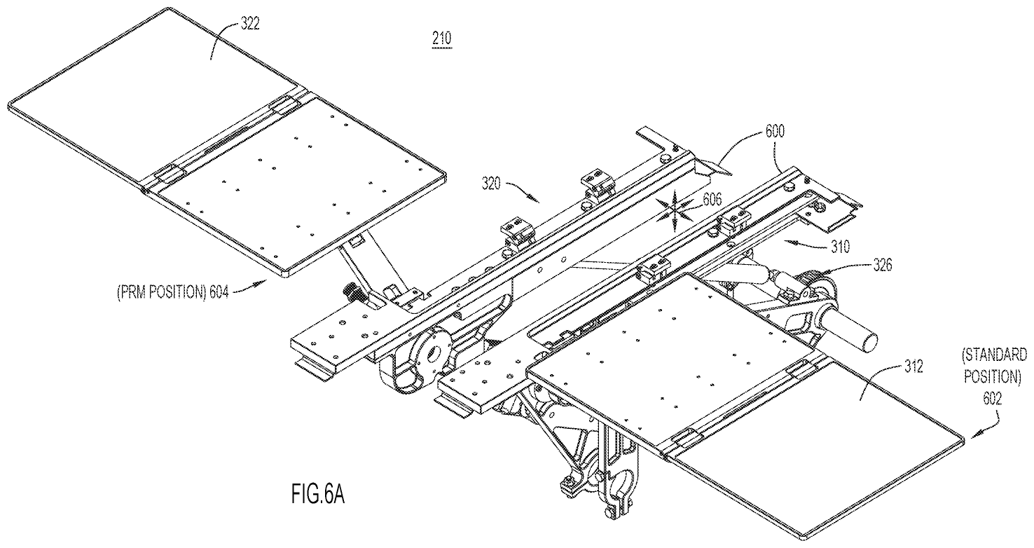

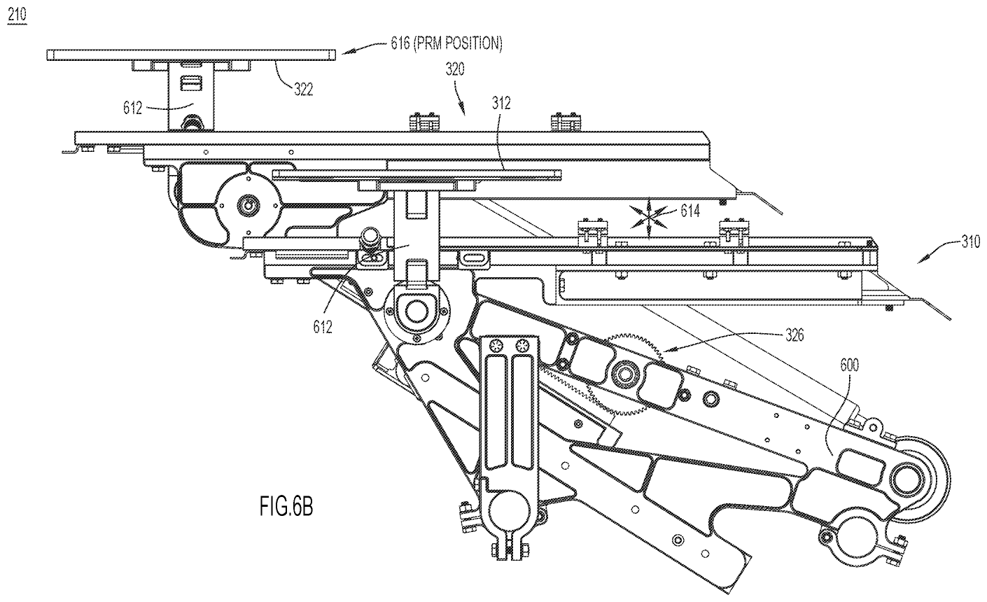

FIG. 6B is a perspective inboard view in which the second table 322 is deployed for use at the PRM position 214 while the first table 312 is deployed for use in the standard position 212, according to an example embodiment.

In FIG. 6B, the first table 312 and the second table 322 are deployed in a substantially similar manner using a flange 612. However, because of an adjustment 614 of the inboard half 320, the second table 322 is vertically higher and extends forward (further away from the seat) in comparison to the first table 312. The second table 322 is shown at a position 616 i.e., the PRM position 214.

With continued reference to FIGS. 1-6B, FIGS. 7A-7C are views, from various perspectives, illustrating components of the console adjustment mechanism 326 of FIGS. 3A-6B, according to an example embodiment. The console adjustment mechanism 326 includes a base rim 702, pulleys 704a-m, a pinion 706, a rail 708, a carriage 710 with rack 712, a belt 714, and a spring 716.

The base rim 702 may be similar to the base rim 402 of FIG. 4B. The base rim 702 may serve as a drive pulley that is configured to rotate to cause adjustments (vertical, horizontal, and/or a combination thereof) to a frame of an adjustable console e.g., the adjustable console 210 or a portion thereof (e.g., the inboard half 320).

The pulleys 704a-m may include any number of pulleys such as a tensioner pulley 704a and an idler pulley 704b (FIGS. 7B and 7C) that hold the belt 714 in place and allow the belt to slide, which then pulls the carriage 710 along the rail 708. The number of pulleys 704a-m may vary depending on a particular use case scenario e.g., the length, width, depth, materials of the belt 714.

The pinion 706 such as the pinion 406 of FIG. 4D is configured to rotate and the belt 714 causes movement or pulls the carriage 710 (the rack 712) along the rail 708. The rail 708 may be a linear rail configured to ensure an overall stability of the load. For example, the rail 708 is a linear guide or a slide rail that ensures that the carriage 710 remains in place. The number of linear rails is not limited to one and may include several rails depending on a particular use case scenario and type of carriage 710.

Based on the pinion 706 locked with the rack 712, the carriage 710 slides along the rail 708 (up, down, forward, back, etc.) i.e., is pulled by the belt 714. For example, the carriage 710 may slide inside two linear rails i.e., linear rails may be positioned on each side of the carriage 710. That is, the carriage 710 may be nested inside the linear rails to keep the rack 712 captive. The carriage 710 is configured to slide along the rail 708 horizontally, vertically, or at an angle thereof depending on a particular deployment and use case scenario. In one example embodiment, the carriage 710 slides along the rail 708 at an approximate 30° degrees, thus causing the adjustable console 210 (e.g., the inboard half 320) to be raised with the lift assist from the spring 716. The spring 716 such as the spring 410 of FIG. 4B may be a gas spring that provides the lift assist for adjusting the inboard half 320.

In FIG. 7A, the console adjustment mechanism 326 is being stowed (not used) and in FIGS. 7B and 7C, the console adjustment mechanism 326 is deployed (being used to lift the inboard half 320, for example).

Specifically, in FIG. 7A, the console adjustment mechanism 326 is not deployed i.e., the adjustable console 210 is in the standard position 212 of FIG. 2. This means that the pinion 706 is at an upper portion of the rack 712, shown at 720 and the spring 716 (that provides a lift assist) is stowed or rested, shown at 722. Further, the carriage 710 extends beyond the rail 708 in a resting position 724. This is just an example of the resting position 724 for the carriage 710. In another example embodiment, the carriage 710 may align with the rail 708 when in the resting position 724.

In FIGS. 7B and 7C, the console adjustment mechanism 326 is deployed to adjust the position of a console e.g., the inboard half 320, to the PRM position 214 for use by a user in a PRM device when the PRM device is positioned proximate to the seatback i.e., when the PRM device is secured in the seating area.

The carriage 710 and the pinion 706 control the motion of the inboard half 320. In particular, the motion is controlled by gearing the motion to track along the same motion that a base frame 730 pivots at because holes 732a-k of the base rim 702 (e.g., a drive pulley) are linked directly to the base frame 730, they pivot and index with the base frame 730.

As the base rim 702 rotates, it pushes or causes the pinion 706 to rotate as well, using the belt 714 which pulls the carriage 710 (via the rack 712) upwards, for example, along the rail 708. That is, the pinion 706 is in a deployed position 734 toward a bottom portion of the rack 712.

In one example embodiment, lifting the base frame 730 is used to adjust (e.g., raise) the inboard half 320 of the adjustable console 210 (not shown in FIG. 7B). The spring 716 is configured to provide lift assist i.e., to make it easier to lift the inboard half 320. The spring 716 is in an extended position 736.

The carriage 710 (using the rack 712) slides inside the rail 708. In one example, the rack 712 slides up along the rail 708 at an angle of approximately 30° degrees to an adjusted position 738. The carriage 710 may slide up or down along one or more linear rails at various angles depending on a particular use case scenario and/or deployment. In the adjusted position 738, the carriage 710 protrudes at the other end or side of the rail 708. In yet another example embodiment, the carriage 710 may align with the rail 708 at the other side of the rail 708. In yet another example embodiment, the rail 708 may now protrude at both ends (sides) and the carriage 710 may be within the rail 708 or aligned with the rail 708.

In FIG. 7C, the inboard half 320 is vertically adjusted to enable use of the adjustable console 210 from a PRM device when the PRM device is positioned proximate to the seatback. A pinion pulley 704c is configured to help with movement (e.g., rotations) of the pinion 706. The carriage 710 is pulled by the belt 714 along the rail 708.

With continued reference to FIGS. 1-7C, FIG. 8 is a flow diagram illustrating a method 800 of adjusting the inboard half 320 of FIGS. 3A-7C, according to an example embodiment. The method 800 involves an adjacent seat 801 and a seat 802 having the base 102 and the seatback 104 of FIGS. 1 and 2, and the console adjustment mechanism 326 of FIGS. 3A-7C. The method 800 further involves a spring-loaded lock 804, an activation button 806, a base frame 808 of the seat 802. The adjacent seat 801 is stationary and cannot accommodate a PRM device i.e., cannot be adjusted to the PRM position 214 of FIG. 2.

The spring-loaded lock 804 includes a head 810 and a banana slot 812. The banana slot 812 has a first groove 814 at one end thereof and a second groove 816 at another end thereof. When the head 810 is in the first groove 814, the seat 802 is in a locked position. That is, at 820, the head 810 of the spring-loaded lock 804 is nested in the first groove 814 of the banana slot 812. As such, the seat 802 is in the standard position 212 of FIG. 2. That is, the base 102 is unfolded to accommodate or seat a user on the base 102 such as a passenger in an aircraft or in a vehicle.

At 822, the activation button 806 may be pressed by a user. The activation button 806 may be a mechanical button that causes the release of the head 810 from the first groove 814 into the banana slot 812. In yet another example embodiment, the activation button 806 may be an electrical button. When the activation of the activation button 806 is detected by a controller, for example, it causes a motor (not shown) to release the head 810 from the first groove 814 into the banana slot 812. When the head 810 is released from the locked position i.e., unlocked position, the base 102 is configured to fold against the seatback 104. That is, the base 102 is configured to pivot and/or move freely. The base frame 808 is configured move freely to be folded and/or abutted against the seatback 104.

At 824, when the base 102 is being folded to a stowed position (i.e., the PRM position 214 of FIG. 2), the console adjustment mechanism 326 is activated by the movement of the base frame 808. The console adjustment mechanism 326 causes the inboard half 320 to be vertically adjusted to the PRM position 214 of FIG. 2. In one example embodiment, when an activation of the activation button 806 is detected, a controller may control the base 102 to fold against the seatback 104 and at substantially same time, activate the console adjustment mechanism 326.

For example, the holes 732a-k of the base rim 702 of FIGS. 7B are fixed in place and are attached to the base frame 808 e.g., a six-bolt pattern linked to a drive shaft cause the adjustable console 210 to be vertically adjusted. As noted above, the base rim 702 drives the belt 714 around the pinion 706, thus pushing the carriage 710 up into the adjusted position 738 i.e., the PRM position 214 of FIG. 2.

By releasing the activation button 806, the head 810 of the spring-loaded lock 804 is snapped back to being nested in the banana slot 812 i.e., in the second groove 816 (at a second end of the banana slot 812 opposite from the first end, the first groove 814). The adjustable console 210 is now adjusted to the PRM position 214.

At 826, the head 810 is locked in the second groove 816 with the base 102 being folded against the seatback 104 of the seat 802 and the adjustable console 210 having the inboard half 320 in a raised position for accessing the at least one console-based feature from the PRM device e.g., a wheelchair 830 when the wheelchair 830 is positioned proximate to the seatback 104.

Moreover, using the activation button 806, the base 102 is pushed down and away from the seatback 104 (unfolded). For example, when another press of the activation button 806 is detected, the base 102 is unfolded to accommodate a user without a PRM device. This, in turn, activates the console adjustment mechanism 326 that drives the adjustable console 210 to vertically adjust from the PRM position 214 back to the standard position 212. The activation button 806 is then released, which locks the head 810 of the spring-loaded lock 804 in the banana slot 812 (in the first groove 814).

The method 800 is just one example of the seat 802 being adjusted to the PRM position 214 of FIG. 2 together with or in synchronization with the adjustable console 210. The method 800 may involve co-dependent adjustments of the seat 802 and the adjustable console 210.

In another example embodiment, the method 800 may involve independent adjustments of the seat 802 and the adjustable console 210. That is, the adjustable console 210 may include an independent lockout feature and may adjust independently of the seat 802. While the base 102 is to be folded against seatback 104 (stowed) to accommodate various types of PRM devices, the adjustable console 210 may be adjusted differently for different types of PRM devices. As such, it is operated independently of folding the base 102 of the seat 802. For example, the console adjustment mechanism 326 may be activated to raise the adjustable console 210 when the wheelchair 830 is positioned proximate to the seatback 104 and to lower the adjustable console 210 when a scooter is positioned proximate to the seatback 104. In yet another example embodiment, the adjustable console 210 is adjusted at an angle for yet another PRM device type. In one example embodiment, there are multiple PRM positions for the adjustable console 210, each specific to a particular PRM device that is positioned proximate to the seatback 104 and/or the PRM.

Traditionally, center consoles are fixed in place and do not have multiple positions to better suit passenger comfort. In techniques presented herein, provide adjustable consoles (e.g., center consoles) that fit passengers in PRM devices. One or both sides of the console may be adjusted independently of one another. In other words, while example embodiments presented above provide for an adjustable inboard half, in other example embodiments, the outboard half may also be adjustable and include a console adjustment mechanism.

Moreover, the techniques presented herein include adjusting other aspects of a seating area to accommodate a user in a PRM device. For example, a headrest (e.g., in an aircraft seating apparatus or a passenger seat in a vehicle) may also be adjusted between a standard position and a PRM accessible position (PRM position) to accommodate a PRM e.g., a wheelchaired passenger.

FIG. 9 is a diagram illustrating a seating apparatus 900 in which a headrest 910 is adjustable between a standard position 912 and a PRM position 914, according to an example embodiment. The seating apparatus 900 includes the headrest 910 designed to move forward from a seat 920 to the PRM position 914 to accommodate a user in a PRM device and aft to return to the standard position 912.

While it is not uncommon for the headrests to slide up and down to accommodate users of different heights, in one or more example embodiments, the headrest 910 is further configured to slide between the standard position 912 and the PRM position 914 (extend forward and aft by approximately 3 to 9 inches), shown at 916. The PRM position 914 extends the headrest 910 by approximately 3-9 inches from the seat 920 to accommodate a user in a PRM device. This is just one example of an adjustable headrest.

In yet another example embodiment, the headrest 910 may be adjusted to various other positions to better accommodate individual users in their PRM devices. In addition to the standard position 912 and the PRM position 914, there may be additional PRM positions therein between. In other words, a locking mechanism may be provided, which locks the headrest 910 at a custom position selected by the user e.g., at 1 inch extended forward, at 1.3 inches extended forward, etc. In yet another example embodiment, the headrest 910 may be adjusted at an angle (a combination of vertical and horizontal movements). The headrest 910 is position adaptable. Passengers seated in their PRM devices e.g., wheelchairs, can position the headrest 910 in a position that enables them to use the headrest 910 even though they are seated in their own PRM devices.

With continued reference to FIG. 9. FIGS. 10A and 10B are side views illustrating the headrest 910 of FIG. 9 in the standard position 912 and the PRM position 914, respectively, according to an example embodiment. The headrest 910 includes a self-contained mechanism 1012. The self-contained mechanism 1012 includes a lever 1022, at least a pair of stop blocks 1024, respective sliders 1026, a ratcheting mechanism 1028 with a plurality of teeth 1030, and a scissor type mechanism 1032.

The self-contained mechanism 1012 enables the headrest 910 to move between the standard position 912 and the PRM position 914 which is ergonomically well-suited for a PRM passenger such as the wheelchaired passenger. Headrests typically do not have the ability to travel forward and aft. The headrest 910, on the other hand, is adjustable to various positions in a horizontal direction i.e., forward-away from the seat 920 and back towards the seat 920 and/or at an angle.

In FIG. 10A, the headrest 910 is in the standard position 912. The self-contained mechanism 1012 is enabled by releasing the lever 1022. When the lever 1022 is released, the headrest 910 is freely movable in a horizontal (and optionally vertical) directions into multiple different positions that may be more comfortable for some users. In one or more example embodiments, the self-contained mechanism 1012 is configured to provide adjustment of the headrest 910 vertically and horizontally (e.g., at an angle) to accommodate a PRM user in a PRM device when the PRM device is positioned proximate to the seat 920. For example, the ratcheting of the self-contained mechanism 1012 allows for multiple forward and aft positions.

In FIG. 10B, the headrest 910 is in the PRM position 914, according to an example embodiment. Specifically, the headrest 910 uses a scissor-lift style mechanism (the scissor type mechanism 1032) or a slider crank. The scissor type mechanism 1032 includes a pair of arms that pushes the body of the headrest 910 forward and away from the seat 920. In one example embodiment, the scissor type mechanism 1032 may further extend the headrest 910 upwards or downwards as preferred by the passenger. When the pair of arms are extended, the headrest 910 protrudes forward with respect to the seat 920.

For example, when the lever 1022 in FIG. 10A is pulled down, the pair of stop blocks 1024 are released and respective sliders 1026 move freely up and down in the ratcheting mechanism 1028. As the respective sliders 1026 move, the pair of arms of the scissor type mechanism 1032 is pulled away from the respective sliders 1026. That is, when the respective sliders 1026 are moving freely up and down, the forward motion of the scissor type mechanism 1032 is enabled. The pair of stop blocks 1024 are then used to lock the headrest 910 into a respective position by snapping the pair of stop blocks 1024 back into place. The plurality of teeth 1030 of the ratcheting mechanism 1028 lock or secure the headrest 910 in the selected position.

In one example embodiment, the number of user selected positions for the headrest 910 may be based on the number of teeth such that by increasing the number of teeth in the ratcheting mechanism 1028, the adjustable positions for the headrest 910 also increase. In yet another example embodiment, a friction device may be used to clamp a pair of stoppers (such as the stop blocks 1024) at any position thus providing even more flexibility for adjusting the headrest 910.

In one or more example embodiments, instead of being mounted directly onto the back and fixed in place, the headrest 910 includes a sliding support panel to slide forward and back depending on the passenger's convenience.

In one or more example embodiments, the seating area is adjusted to accommodate a user in a PRM device. More specifically, a seating area on an aircraft is provided with an adjustable center console and/or headrest. When the base of a seat is folded to the PRM position, the console is vertically (up/down) adjusted and the headrest is horizontally (pivots forward/back) adjusted.

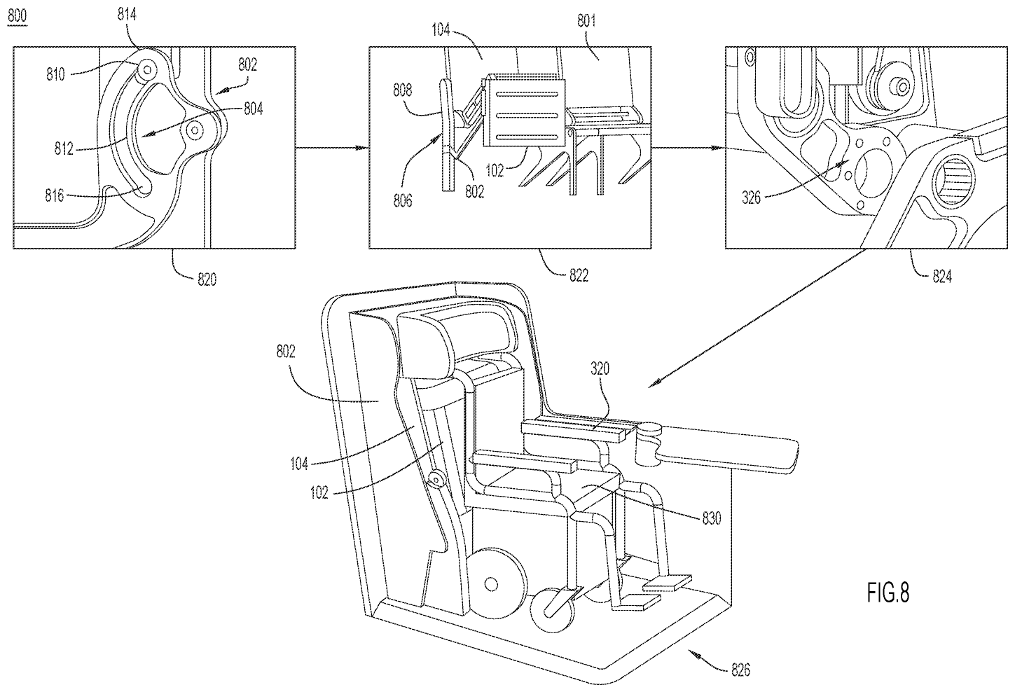

In one example embodiment, when a release or press of the activation button 806 of FIG. 8 is detected, both the console and the headrest may be adjusted to the PRM position synchronously, at substantially same time, co-dependently. For example, the activation button 806 may cause an inboard half of a center console to move upwards and the lever 1022 to be released such that the headrest 910 is moved to the PRM position 914. In another example embodiment, the headrest may be adjusted independently of the seat and/or the center console.

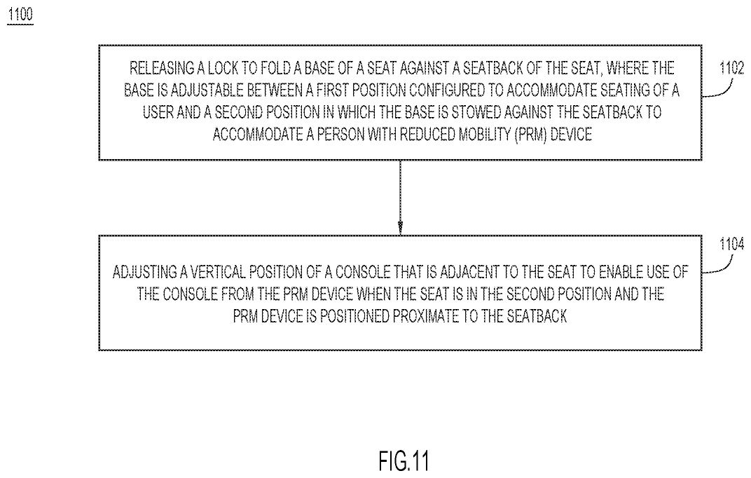

FIG. 11 is a flowchart illustrating a method 1100 of adjusting a vertical position of a console, according to an example embodiment.

The method 1100 involves, at 1102, releasing a lock to fold a seatback of a seat against a base of the seat. The seatback is adjustable between a first position configured to accommodate seating of a user and a second position in which the base is stowed against the seatback to accommodate a person with reduced mobility (PRM) device.

The method 1100 further involves, at 1104, adjusting a vertical position of a console that is adjacent to the seat to enable use of the console from the PRM device when the seat is in the second position and the PRM device is positioned proximate to the seatback.

In one form, the method 1100 may further involve adjusting a headrest of the seat to move the headrest horizontally away from the seatback to accommodate the user in the PRM device.

In another form, the method 1100 may further involve detecting an activation of a button that releases a head of the lock to adjust the seat to the PRM position. The PRM device may be a wheelchair.

According to one or more example embodiments, the method 1100 may further involve adjusting the vertical position of the console to enable use of the console by the user in the first position when the seat is unfolded.

In one instance, the operation 1104 of adjusting the vertical position of the console may involve raising the console to align the console with the PRM device. In yet another instance, the operation 1104 of adjusting the vertical position of the console may involve lowering the console to align the console with the PRM device.

According to one or more example embodiments, the operation 1104 of adjusting the vertical position of the console may involve raising an inboard half of the console to align the console with the PRM device while keeping an outboard half of the console in a fixed position for access by the user in an adjacent seat.

In another example embodiment, a seating apparatus is provided. The seating apparatus includes a seat having a seatback and a base that is foldable against the seatback to accommodate a person with reduced mobility (PRM) device and a console adjacent to the seat. At least a portion of the console is vertically adjustable with respect to the seatback to enable use of the console from the PRM device when the PRM device is positioned proximate to the seatback.

In one form, the console may be a center console positioned between the seat and an adjacent seat having another seatback and another base.

In one instance, the center console may include an outboard half that has a first feature and is configured to be fixed in place for the adjacent seat. The center console may further include an inboard half that has a second feature and is configured to be vertically adjustable for an access to the second feature from the PRM device when the PRM device is positioned proximate to the seatback.

According to one or more example embodiments, the PRM device may be a wheelchair.

According to one or more example embodiments, each of the first feature and the second feature may be one or more of: a tray table, a video monitor, an armrest, a cup holder, a magazine holder, a book holder, or media controls.

In another form, the console may include an outboard half having a first feature and being configured to be fixed in place. The console may further include an inboard half having a second feature and a console adjustment mechanism that is configured to vertically adjust the inboard half with respect to the PRM device for accessing the second feature from the PRM device when the PRM device is positioned proximate to the seatback.

In one instance, the console adjustment mechanism may be configured to lower or raise the inboard half for accessing the second feature from the PRM device.

In another instance, the console adjustment mechanism may include a rail and a carriage that is configured to move along the rail to raise or lower only the inboard half while the outboard half remains fixed in place. The console adjustment mechanism may further include a belt that is configured to pull the carriage along the rail and at least one pulley configured to rotate and cause the belt to slide.

According to one or more example embodiments, the console adjustment mechanism may further include a spring that is attached to the carriage and configured to provide a lift assist in raising the inboard half.

In one form, the seat may be adjustable between a first position to accommodate seating of a passenger in a vehicle and a second position to accommodate a PRM passenger in the PRM device in the vehicle.

In another form, the seat may be adjustable between a first position to accommodate seating of a passenger in an aircraft and a second position to accommodate a PRM passenger in the PRM device in the aircraft.

According to one or more example embodiments, the seating apparatus may further include an adjustable headrest that is configured to move horizontally with respect to the seat to accommodate a passenger in the PRM device.

In one instance, the adjustable headrest may include a self-contained mechanism for moving the adjustable headrest forward and aft with respect to the seat.

In one form, the self-contained mechanism may include a pair of stop blocks configured to lock the adjustable headrest in a particular position and a lever that is configured to release the pair of stop blocks for horizontally moving the adjustable headrest with respect to the seat. The self-contained mechanism may further include a ratcheting mechanism having a plurality of teeth and at least one slider that moves up and down along the plurality of teeth for securing the adjustable headrest at the particular position.

In yet another example embodiment, a seating apparatus is provided. The seating apparatus includes a seat having a seatback and a base that is foldable against the seatback to accommodate a person with reduced mobility (PRM) device. The seating apparatus further includes a console adjacent to the seat. The console includes an outboard half configured to be fixed in place and an inboard half configured to be vertically adjustable to be accessible from the PRM device when the PRM device is positioned proximate to the seatback.

In one form, the inboard half may further include a console adjustment mechanism that is configured to move the inboard half between a first position to accommodate seating of a user and a second position to provide access to the console for the user in the PRM device.

In another form, the outboard half may include a first feature accessible by the user. The inboard half may further include a second feature accessible by the user in the second position.

According to one or more example embodiments, the PRM device may be a wheelchair. Also, each of the first feature and the second feature may be one or more of: a tray table, a video monitor, an armrest, a cup holder, a magazine holder, a book holder, or media controls.

According to yet another example embodiment, a seat console apparatus is provided. The seat console apparatus includes a frame that is configured to be positioned between a first seat and a second seat. The second seat is convertible between a first position to accommodate seating of a user and a second position to accommodate a person with reduced mobility (PRM) device. The seat console apparatus further includes a console adjustment mechanism configured to move at least a portion of the frame between the first position and the second position.

In one instance, the seat console apparatus may further include at least one console-based feature that is accessible by the second seat.

According to one or more example embodiments, the PRM device may be a wheelchair and the at least one console-based feature may be one or more of: a tray table, a video monitor, an armrest, a cup holder, a magazine holder, a book holder, or media controls.

In one form, the frame may include an outboard half that has a first console-based feature accessible by the user from the first seat. The outboard half may be fixed in place i.e., stationary. The frame may further include an inboard half having a second console-based feature accessible by the user from the second seat. The inboard half may be configured to be vertically adjustable for an access to the second console-based feature from the PRM device when the PRM device is positioned proximate to the seatback.

In one instance, the inboard half may further include a console adjustment mechanism configured to lower or raise the inboard half for accessing the second console-based feature from the PRM device.

In another instance, the console adjustment mechanism may be positioned in the inboard half and may include a rail and a carriage that is configured to move along the rail to raise or lower only the inboard half while the outboard half remains fixed in place. The console adjustment mechanism may further include a belt configured to pull the carriage along the rail and at least one pulley configured to rotate and cause the belt to slide.

According to one or more example embodiment, the console adjustment mechanism may further include a spring attached to the carriage and configured to provide a lift assist in raising the inboard half.

In another form, the inboard half may be adjustable between the first position to accommodate seating of a passenger in a vehicle and the second position to accommodate a PRM passenger in the PRM device in the vehicle.

In yet another form, the inboard half may be adjustable between the first position to accommodate seating of a passenger in an aircraft and the second position to accommodate a PRM passenger in the PRM device in the aircraft.

In yet another example embodiment, a system is provided that includes the apparatuses and operations explained above with reference to FIGS. 1-11.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Accordingly, the appended claims should be construed broadly and, in a manner, consistent with the scope of the present disclosure.

What is claimed is:

1. A seating apparatus comprising:
a seat having a seatback and a base that is foldable against the seatback to accommodate a person with reduced mobility (PRM) device; and
a console adjacent to the seat, wherein at least a portion of the console is vertically adjustable with respect to the seatback to enable use of the console from the PRM device when the PRM device is positioned proximate to the seatback.

2. The seating apparatus of claim 1, wherein the console is a center console positioned between the seat and an adjacent seat having another seatback and another base.

3. The seating apparatus of claim 2, wherein the center console comprises:
an outboard half that includes a first feature and is configured to be fixed in place for the adjacent seat, and
an inboard half that includes a second feature and is configured to be vertically adjustable for an access to the second feature from the PRM device when the PRM device is positioned proximate to the seatback.

4. The seating apparatus of claim 3, wherein the PRM device is a wheelchair.

5. The seating apparatus of claim 3, wherein each of the first feature and the second feature is one or more of: a tray table, a video monitor, an armrest, a cup holder, a magazine holder, a book holder, or media controls.

6. The seating apparatus of claim 1, wherein the console comprises:
an outboard half that includes a first feature and is configured to be fixed in place, and
an inboard half that includes a second feature and a console adjustment mechanism that is configured to vertically adjust the inboard half with respect to the PRM device for accessing the second feature from the PRM device when the PRM device is positioned proximate to the seatback.

7. The seating apparatus of claim 6, wherein the console adjustment mechanism is configured to lower or raise the inboard half for accessing the second feature from the PRM device.

8. The seating apparatus of claim 6, wherein the console adjustment mechanism includes:
a rail;
a carriage that is configured to move along the rail to raise or lower only the inboard half while the outboard half remains fixed in place;
a belt that is configured to pull the carriage along the rail; and
at least one pulley configured to rotate and cause the belt to slide.

9. The seating apparatus of claim 8, wherein the console adjustment mechanism further includes:
a spring that is attached to the carriage and configured to provide a lift assist in raising the inboard half.

10. The seating apparatus of claim 1, wherein the seat is adjustable between a first position to accommodate seating of a passenger in a vehicle and a second position to accommodate a PRM passenger in the PRM device in the vehicle.

11. The seating apparatus of claim 1, wherein the seat is adjustable between a first position to accommodate seating of a passenger in an aircraft and a second position to accommodate a PRM passenger in the PRM device in the aircraft.

12. The seating apparatus of claim 1, further comprising:
an adjustable headrest that is configured to move horizontally with respect to the seat to accommodate a passenger in the PRM device.

13. The seating apparatus of claim 12, wherein the adjustable headrest includes a self-contained mechanism for moving the adjustable headrest forward and aft with respect to the seat.

14. The seating apparatus of claim 13, wherein the self-contained mechanism includes:
a pair of stop blocks configured to lock the adjustable headrest in a particular position;
a lever that is configured to release the pair of stop blocks for horizontally moving the adjustable headrest with respect to the seat; and
a ratcheting mechanism having a plurality of teeth and at least one slider that moves up and down along the plurality of teeth for securing the adjustable headrest at the particular position.

15. A seating apparatus comprising:
a seat having a seatback and a base that is foldable against the seatback to accommodate a person with reduced mobility (PRM) device; and
a console adjacent to the seat and including:
an outboard half configured to be fixed in place, and
an inboard half configured to be vertically adjustable to be accessible from the PRM device when the PRM device is positioned proximate to the seatback.

16. The seating apparatus of claim 15, wherein the inboard half further includes:
a console adjustment mechanism configured to move the inboard half between a first position to accommodate seating of a user and a second position to provide access to the console for the user in the PRM device.

17. The seating apparatus of claim 16, wherein the outboard half includes a first feature accessible by the user and the inboard half includes a second feature accessible by the user in the second position.

18. The seating apparatus of claim 17, wherein the PRM device is a wheelchair and each of the first feature and the second feature is one or more of: a tray table, a video monitor, an armrest, a cup holder, a magazine holder, a book holder, or media controls.

19. A method comprising:
releasing a lock to fold a base of a seat against a seatback of the seat, wherein the base is adjustable between a first position configured to accommodate seating of a user and a second position in which the base is stowed against the seatback to accommodate a person with reduced mobility (PRM) device; and
adjusting a vertical position of a console that is adjacent to the seat to enable use of the console from the PRM device when the seat is in the second position and the PRM device is positioned proximate to the seatback.

20. The method of claim 19, further comprising:
adjusting a headrest of the seat to move the headrest horizontally away from the seatback to accommodate the user in the PRM device.

21. The method of claim 20, further comprising:
detecting an activation of a button that releases a head of the lock to adjust the seat to the PRM position, wherein the PRM device is a wheelchair.
